(19) United States
(12) Patent Application Publication
(10) Pub. No.: US 2002/0188051 A1
(43) Pub. Date: Dec. 12, 2002

(54) Coating with spectral selectivity

(76) Inventor: Gerd Hugo, Schondorf (DE)

Correspondence Address: Gary M. Nath, NATH & ASSOCIATES PLLC, 6th Floor, 1030 15th Street, N.W., Washington, DC, 20005, US

(21) Appl. No.: 09/840,982

(22) Filed: Apr. 25, 2001

Related U.S. Application Data
(63) Continuation of application No. PCT/EP99/08059, filed on Oct. 25, 1999.

(30) Foreign Application Priority Data
Oct. 26, 1998 (DE) 198 49 313.4
Jun. 21, 1999 (DE) 199 28 235.8

(51) Int. Cl. C08K 3/22; B05D 5/06; C08K 3/10; C08K 3/18

(52) U.S. Cl. 524/431; 427/162; 524/407; 524/413

(57) ABSTRACT

The invention relates to a coating with spectral selectivity, especially for deposit surfaces in motor vehicles. Said coating comprises a) a binder with a transmission of 60% or more in the wave length range of near-infrared of 0.7 to 2.5 &mgr;m and a transmission of 40% or more in the wave length range of thermal infrared, b) first pigments absorbing 40% or more of the visible light in the wave length range of 0.35 to 0 7 &mgr;m, having a backscatter of 40% or more in the near-infrared range of 0 7 to 2.5 &mgr;m and having an absorption of 60% or less in the wave length range of thermal infrared, c) second pigments having a backscatter and/or reflection of 40% or more in the wave length range of thermal infrared.

### TECHNICAL FIELD

The present invention relates to a coating with spectral selectivity, especially for the front deposit surface of motor vehicles, which coating absorbs solar energy in the infrared range to a lesser extent and, moreover, has a lower degree of thermal emission.

### PRIOR ART

Increasing significance is attached to a streamlined body in late-model automobiles in order to have the lowest possible aerodynamic drag. In particular, the windscreen is designed increasingly flat.

This has the disadvantage that the surface over the instruments and air outlets, the so-called front deposit surface (ledge), is growing in size all the time. Inevitably, this surface must be tinted dark. If it had a bright or white colour, it would reflect from the inner surface of the windscreen, thus affecting the driver's forward sight.

When exposed to solar radiation, this surface heats considerably since dark colours absorb sunlight, and gives off heat in all directions, primarily in the form of heat radiation. The heat emitted towards the internal face of the windscreen is drawn off on the outside by the wind blast, while the heat radiating into the cabin of the vehicle must be compensated by the cooling air of the air conditioning.

This not only costs energy, but is unhealthy, because both the driver and the passenger are exposed to a cold draft all the time.

Depending on the degree of darkness of the surface and the strength of the solar radiation, temperatures of up to 70° C. may be measured on the surface.

According to the formula

M=ε·σ·T⁴

wherein ε is the degree of emission=0.95 and

σ is the Stefan-Boltzmann constant=5.67·10⁻⁸

T is the absolute temperature=343 Kelvin (70° C.)

the heat output M emitted into the cabin corresponds to a temperature of 70° C. 745 W/m². Therefore, it would be desirable to decrease the absorption of solar energy also with a dark-tinted coating, as is possible with light-coloured or white coatings, and, in addition, to decrease the degree of thermal emission of the coating so as to decrease the energy radiation into the cabin.

### SUMMARY OF THE INVENTION

The invention solves this problem by providing a coating with spectral selectivity comprising

a) a binder having a transmission of 60% or more, preferably 75% or more in the near-infrared wavelength range of 0.7 to 2.5 μm and a transmission of 40% or more, preferably 50% or more in the thermal infrared wavelength range;

b) first pigments which absorb 40% or more, preferably 60% or more of the visible light in the wavelength range of 0.35 to 0.7 μm, have a backscatter of 40% or more, preferably more than 50% in the near-infrared range of 0.7 to 2.5 μm and have an absorption of 60% or less, preferably 50% or less in the thermal infrared wavelength range;

c) second pigments having a backscatter and/or reflection of 40% or more, preferably 50% or more in the thermal infrared wavelength range.

In the context of the present application, the wavelength range of “thermal infrared” is understood to mean the wavelength range from 2.5 to 50 μm, at the very least the range from 5 to 25 μm. A “transmission of 40% or more in the thermal infrared range” therefore means that the transmission should be 40% or more at least in the range from 5 to 25 μm, preferably in the entire range from 2.5 to 50 μm. “Transmission” is understood to mean the transmission effected over the stated wavelength range; the same applies analogously for the terms “absorption” and “backscatter and/or reflection”.

“Spectral selectivity” in the context of the present invention means that the optical characteristics of the coatings or particles in the near or thermal infrared range are markedly different from those in the range of visible light.

Advantageous embodiments of the idea of the invention can be taken from the subclaims and the following detailed description.

### BRIEF DESCRIPTION OF THE DRAWINGS

FIG. 1 shows the degree of spectral reflection of a conventional coating vis-a-vis the coating with spectral selectivity according to the invention.

FIG. 2 shows a particularly preferred coating with spectral selectivity according to the invention having aligned platelet-shaped pigments which reflect infrared.

FIG. 3 shows the absorption and reflection behaviour of lacquer coatings comprising surface-treated metal pigments according to an exemplary embodiment in the form of a diagram.

### BEST MODE OF CARRYING OUT THE INVENTION

A preferred coating with spectral selectivity according to the invention comprises

a) a binder having a transmission of 75% or more in the near-infrared wavelength range of 0.7 to 2.5 μm and a transmission of 50% or more in the thermal infrared wavelength range;

b) first pigments which absorb 60% or more of the visible light in the wavelength range of 0.35 to 0.7 μm have a backscatter of 50% or more in the near-infrared range and have an absorption of 50% or less (which corresponds to a transmission of 50% or more) in the thermal infrared wavelength range;

c) second pigments having a backscatter and/or reflection of 50% or more in the thermal infrared wavelength range.

The fact that the binder is selected from at least one of the following groups constitutes an advantageous development of the idea of the invention:

a) aqueous dispersions and emulsions on the basis of acrylate, styrene acrylate, polyethylene, polyethylene oxidate, ethylene acrylic acid copolymers, methacrylate, vinyl pyrrolidone vinyl acetate copolymers, polyvinyl pyrrolidone, polyisopropyl acrylate, polyurethanes, terpene and rosin resins;

b) binders containing solvents, selected from acryl, cyclised and butyl rubber, hydrocarbon resins, terpene resins, nitro, acetyl and ethyl cellulose, α-methyl styrene acrylonitrile copolymers, polyester imides, acrylic acid butyl esters, poly(meth)acrylic acid esters, polyurethanes, aliphatic polyurethanes, chlorosulfonated polyethylene and

c) thermoplastic materials such as polyolefins and polyvinyl compounds, especially polyethylene, polypropylene, Teflon®, polyamide.

It an advantageous development of the idea of the invention that the first pigments are selected (i) from the group of inorganic pigments, selected from lead compounds, zinc, iron, chromium, cadmium, barium, titanium, cobalt, aluminium-silicon compounds, especially red iron oxides, chrome oxide green, chrome oxide hydrate, ultra marine blue and iron cyanide blue, and/or (ii) from the group of organic pigments, comprising natural dyes of animal and plant origin as well as synthetic organic dyes and pigments, especially monoazo pigments, diazo pigments, indigo pigments, perylenes, quinacridones, dioxazines, metal-free phthalocyanines, especially phthalocyanine pigment blue.

It is a particularly advantageous embodiment of the idea of the invention that the first pigments are selected from the group of transparent and/or translucent pigments, especially from the group of transparent iron oxides and from the group of transparent organic pigments.

It is an advantageous development of the idea of the invention that the second pigments have a platelet shape and are selected from at least one of the following groups:

a) metals and/or metal alloys, selected from aluminium, aluminium bronze, antimony, chromium, iron, gold, iridium, copper, magnesium, molybdenum, nickel, palladium, platinum, silver, tantalum, bismuth, tungsten, zinc, tin, bronze, brass, nickel silver, a nickel/chromium alloy, niccolite, constantan, manganin and steel and mixtures thereof;

b) electrically non-conducting materials coated and/or covered with metal or metal alloys selected from aluminium, aluminium bronze, antimony, chromium, iron, gold, iridium, copper, magnesium, molybdenum, nickel, palladium, platinum, silver, tantalum, bismuth, tungsten, zinc, tin, bronze, brass, nickel silver, a nickel/chromium alloy, niccolite, constantan, manganin, steel and electrically conducting stannous oxide; and mixtures thereof;

c) laminated pigments composed of at least three layers, the middle layer having a smaller refractive index than the outer layers and the materials thereof being selected from the group of materials having a transmission of ≧20%, preferably ≧40% in the wavelength range of 5 to 25 μm, especially materials from at least one of the following groups:

(1) inorganic materials such as metal sulfides, selected from zinc sulfide and lead sulfide, metal selenides such as zinc selenide, fluorides selected from calcium fluoride, lithium fluoride, barium fluoride and sodium fluoride, antimonides such as indium antimonite, metal oxides selected from zinc oxide, magnesium oxide, antimony oxide, from barium titanate, barium ferrite, calcium sulfate, barium sulfate and from mixed crystals of the enumerated materials and electrically conducting tin oxide;

(2) organic substances selected from acrylate, styrene acrylate, polyethylene, polyethylene oxidate, chlorosulfonated polyethylene, ethylene acrylic acid copolymer, methacrylate, vinyl pyrrolidone vinyl acetate copolymers, polyvinyl pyrrolidone, polyisopropyl acrylate, polyurethanes, cyclised rubber, butyl rubber, hydrocarbon resin, α-methyl styrene acrylonitrile copolymers, polyester imide, acrylic acid butyl ester, polyacrylic acid ester, the refractive index of which may optionally be increased by adding colloidal metal particles.

Of course, it is possible to use several kinds of the above-listed second pigments in the coatings of the invention, for example a laminated pigment together with a simple platelet-shaped pigment or a platelet-shaped pigment together with a spherical pigment (as described below), as long as the backscatter and reflection characteristics of the second pigments, which constitute part of the invention, are preserved on the whole.

It is another advantageous development of the idea of the invention that the second pigments are surface-treated, platelet-shaped metal pigments the surfaces of which having been treated in such a manner that they absorb 40% or more, preferably 60% or more of the visible light in the wavelength range of 0.35 to 0.7, have a reflection of 50% or more, preferably 60% or more in the near-infrared range of 0.7 to 2.5 μm and have a reflection of 40% or more, preferably 50% or more in the thermal infrared wavelength range, of 2.5 to 50 μm, at least however in the range of 5 to 25 μm.

It is another advantageous development of the idea of the invention that the second pigments are approximately spherical and are substantially single crystals, the mean diameter d of the single crystals being determined by the formula

d=14 μm/2.1·(n_{T 14}−n_{B 14}),

wherein n_{T 14} is the refractive index of the spherical particle at a wavelength of 14 μm and n_{B 14} is the refractive index of the binder at a wavelength of 14 μm.

It is another advantageous development of the idea of the invention that the second pigments are selected from the group consisting of metal sulfides such as zinc sulfide and lead sulfide, from metal selenides such as zinc selenide, from fluorides such as calcium fluoride, lithium fluoride, barium fluoride and sodium fluoride, from carbonates such as calcium carbonate or magnesium carbonate, from antimonides such as indium antimonide, from metal oxides such as zinc oxide, magnesium oxide, antimony oxide, from barium titanate, barium ferrite, calcium sulfate, barium sulfate and of mixed crystals of said substances selected from mixed crystals of barium sulfate with zinc sulfide.

It is another advantageous development of the idea of the invention that the second pigments are hollow spheres having a diameter of 10 to 100 μm, preferably 10 to 30 μm, the wall of which consists of at least one material selected from acrylate, styrene acrylate, acrylonitril copolymer, polyethylene, polyethylene oxidate, chlorosulfonated polyethylene, ethylene acrylic acid copolymer, methacrylate, vinyl pyrrolidone vinyl acetate copolymer, vinylidene chloride copolymer, polyvinyl pyrrolidone, polyisopropyl acrylate, polyurethane, from cyclised rubber, butyl rubber, hydrocarbon resin, α-methyl styrene acrylonitrile copolymer, polyester imide, acrylic acid butyl ester, polyacrylic acid ester.

It is another advantageous development of the idea of the invention that the second pigments are a mixture of single crystals and hollow spheres.

It is another particularly advantageous development of the idea of the invention that the second platelet-shaped pigments in the binder are aligned in such a manner that they form an angle of 30° to 60° to the normal line of the surface.

According to the invention, additional pigments may be used along side of the pigments already mentioned to achieve a matting effect, said additional pigments having a transmission of 40% or more, preferably 50% or more in the thermal infrared wavelength range of 2.5 to 50 μm, at least however, in the range of 5 to 25 μm, being approximately spherical and substantially being single crystals, the mean diameter d of the single crystal being determined by the formula

d=λ/2.1·(n_{T}−n_{B}),

wherein n_{T} is the refractive index of the spherical particle at the wavelength λ, n_{B} is the refractive index of the binder at a wavelength of λ and λ is a wavelength in the range of visible light.

It is another advantageous development of the idea of the invention that the additional pigments are selected from the group of metal sulfides such as zinc sulfide and lead sulfide, from metal selenides such as zinc selenide, from fluorides such as calcium fluoride, lithium fluoride, barium fluoride and sodium fluoride, from carbonates such as calcium carbonate or magnesium carbonate, from antimonides such as indium antimonide, from metal oxides such as zinc oxide, magnesium oxide, antimony oxide, from barium titanate, barium ferrite, calcium sulfate, barium sulfate and from mixed crystals selected from mixed crystals of barium sulfate with zinc sulfide.

It is another advantageous development of the idea of the invention that additional pigments are used for matting purposes, said pigments having a transmission of 30% or more, preferably 40% or more in the thermal infrared wavelength range of 2.5 to 50 μm, at least however of 5 to 25 μm. Such pigments may be selected from the group of opaque polymeric pigments and/or organic pigments consisting of a polymer selected from acrylate, styrene acrylate, polyethylene, polyethylene oxidate, chlorosulfonated polyethylene, ethylene acrylic acid copolymers, methacrylate, vinyl pyrrolidone vinyl acetate copolymers, polyvinyl pyrrolidone, polyisopropyl acrylate, polyurethanes or from cyclised rubber, butyl rubber, hydrocarbon resin, α-methyl styrene acrylonitril copolymers, polyester imide, acrylic acid butyl ester, polyacrylic acid ester, said pigments having and/or forming a cavity in the dry state and the size of the polymeric or organic pigments being selected in such a manner that their mean diameter is 0.2 to 2.0 μm, preferably 0.4 to 0.8 μm.

It is another advantageous development of the idea of the invention that transparent red, green and blue pigments are additionally used as the first pigments for the purpose of producing particularly dark colours.

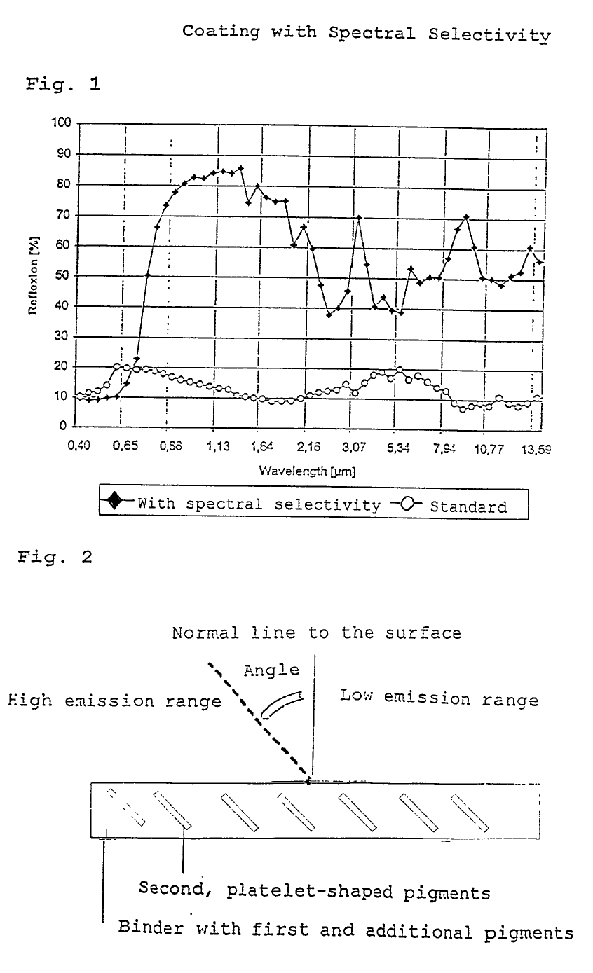

FIG. 1 shows the degree of spectral reflection of a conventional coating (called the standard in this case) vis-à-vis the coating with spectral selectivity according to the invention. Solar absorption and thermal emission, respectively, are calculated from 100% minus the value of the reflection diagram shown. In order to determine the degree of solar absorption, the spectral absorption of a coating is placed in relation to the spectral energy distribution of the sun (about 5800 Kelvin black-body radiator). For determination of the degree of thermal emission, the degree of spectral absorption (=degree of emission) of the coating is placed in relation to the distribution of spectral energy of a black-body radiator at room or environmental temperature (i.e. 300 to 350 Kelvin).

As a rule, the degree of spectral reflection or backscatter of surfaces is measured by means of a spectral Ulbricht globe photometer. The absorption and the degree of emission may be calculated as shown from the reflection measured on a surface. Transmission of materials is measured with the usual FTIR spectral photometers.

The degree of solar absorption, αₛₒₗ is 0.85 with the standard colour, the degree of thermal emission ε_{IR} is 0.88. This means that 85% of solar radiation is absorbed and 88% emitted in the form of heat.

The figures for the coating of the invention with spectral selectivity are much more favourable. The degree of solar absorption αₛₒₗ is 0.58, and the degree of thermal emission ε_{IR} is but 0.46. Only 58% of the solar energy is absorbed, of which 46% are re-emitted.

According to the invention, it is also possible to further reduce heating by the sun of the front surface over the instrument panel by designing the degree of emission of the surface in dependence on the angle, i.e. in such a manner that the surface has a high degree of emission on the side facing the windscreen and a low degree of emission on the side facing the cabin.

In a particularly preferred coating with spectral selectivity according to the invention, this is achieved by aligning infrared-reflecting, platelet-shaped pigments in a binder in such a manner that they form angles of 30° to 60° towards the normal line of the surface and retain these angles after curing of the coating. This is illustrated in FIG. 2.

In case of non-magnetic, platelet-shaped pigments, this takes place in an electrostatic field and, in case of magnetic, platelet-shaped pigments in an electro- or permanent-magnetic field.

When using transparent or translucent pigments for colouring the coating of the invention, the aesthetically pleasing effect that the coating appears markedly brighter in the direction of the cabin than in the direction of the windscreen is achieved. Despite the optically bright appearance of the surface over the instrument panel, said surface is not reflected in the windscreen, because is appears dark in this direction.

The use of synthetic organic pigments such as azo pigments and perylene pigments as the first pigments has turned out to be of particular advantage for the coating with spectral selectivity according to the invention.

A mixture of red organic pigments with blue organic and green organic pigments as the first pigments has been shown to be especially advantageous for forming a dark coating with spectral selectivity according to the invention.

The following first pigments have turned out to be particularly advantageous in preparing a coating with spectral selectivity according to the invention for forming hues appearing dark to the eye with a high degree of reflection in the near infrared range:

### Organic Pigments

Heucophthal Blau RF, Heubach

Hostaperm Blue B2G, Hoechst-Celanese

Phthaloycyanine Blue, Lightfast) Blue 15, 15:3 and 15:4, Sun Chemical

Hostaperm Grün, Hoechst-Celanese

HS-310 Solvaperm Rot G, Hoechst-Celanese

Novoperm Rot Violet MRS, Hoechst-Celanese

Sunfast Magenta 290, Sun Chemical

Hostatint Rot FGR, Hoechst

Hostatint Grün GG, Hoechst

Hostatint Blau B2G, Hoechst

Paliogen Schwarz L0086 BASF

Heliogen Blau L6875 F, BASF

D&C Green # 5, Simple Pleasures Old Saybrook, Conn. 06475-1253

D&C Red, # 33 Simple Pleasures Old Saybrook

FD&C Blue # 1, Simple Pleasures Old Saybrook

### Inorganic Pigments

Red iron oxides

Chrome oxide green

Blue iron cyanides

These pigments may be used either alone or in mixed form as the “first pigments” in accordance with the present invention.

Aluminium flakes with an iron oxide coating as the second platelet-shaped pigments, such as Paliochrom Gold L2000, Gold L2020 and Paliochrom Orange L2800 by BASF, have turned out to be especially advantageous for preparing a dark coating with spectral selectivity according to the invention with high reflection in the near-infrared range. The iron oxide layer alone causes a certain absorption in the visible range and high reflection in the near-infrared range.

Stainless steel flakes by Novamet aligned in a magnetic field in the undried coating are particularly advantageous for preparing a coating of the invention with spectral selectivity and a degree of thermal emission which is dependent on the angle.

In addition, the following combinations of the following binder and pigment types have turned out to be of particular advantage for forming a coating with spectral selectivity:

| Binder | First pigments | Second pigments |
|---|---|---|
| Lacquers containing | Inorganic pigments | Metal flakes, optionally |
| solvents | | aligned |
| Lacquers containing | Organic pigments | Metal flakes, optionally |
| solvents | | aligned |
| Aqueous lacquers and | Organic pigments | Metal flakes, optionally |
| dispersions | | aligned |
| Aqueous lacquers and | Organic pigments | Infrared-transparent |
| dispersions | | single crystals having |
| | | a grain size of ≧5 μm |
| Aqueous lacquers and | Organic pigments | Mixture of infrared- |
| dispersions | | transparent single |
| | | crystals having a grain |
| | | size of ≧5 μm and |
| | | hollow spheres |
| Aqueous lacquers and | Organic pigments | Laminated pigments |
| dispersions | | |
| Acryl-based water | Paliogen Schwarz | Paliochrom Gold L2000 |
| lacquer | L0086 | |
| | Hostatint Rot FGR | |
| Aqueous dispersions | D&C Red # 33 | Aquasil BP 5500 |
| of styrene acryl and | FD&C Blue # 1 | Silberline, |
| polyethylene oxidate | Sachtolith HDS | Paliochrom Orange |
| | | L2800 |
| Cyclised rubber | Iron oxide red | Zinc flakes (e.g. |
| lacquer | Ultra marine blue | by Novamet) |
| Acryl polyethylene | Paliogen Schwarz | Paliochrom Orange |
| oxidate-based water | L0086 | L2800 |
| lacquer | Hostatint Rot FGR | Paliochrom Gold L2020 |
| | Hostatint Blue B2G | |
| Styrene acrylate-based | Hostatint Blau B2G | Alu Flakes (e.g. Reflexal |
| aqueous dispersion | Sachtolith HD-S | 100 by Eckhart) |
| Thermoplastic | Combination of red, | Stapa Standard Lack 900 |
| polypropylene layer | blue and green | Feuerrot, by Eckhart |
| | pigments, e.g. | |
| | PV-Echtrot ESB02, | |
| | PV-Echtblau B2G01, | |
| | PV-Echtgrün GG01, | |
| | by Hoechst | |
| Styrene acrylate | Hostatint Blau B2G | Coarse zinc sulfide |
| dispersion with | Sachtolith L | (e.g. E8Z 7 μm, by |
| Poligen PE | | Sachtleben, Expancel |
| | | 461DE20) |
| Acrylate dispersion | Paliogen Schwarz | Coarse zinc sulfide |
| with polyethylene | L0086 | (e.g. E8Z 7 μm, by |
| oxidate | Ropaque 62LOE | Sachtleben, Expancel |
| | | 461DE20) |
| Styrene acrylate | Mixture of inorganic | Laminated pigment of |
| dispersion, optionally | pigments, | precipitated zinc sulfide |
| with Poligen PE | e.g. Hostatint Blau | on calcium fluoride |
| | B2G, Paliogen | |
| | Schwarz L0086, | |
| | Ropaque 62LOE | |
| Thermoplastic | PV-Echtrot ESB02 | Angle-orientated metal |
| polypropylene layer | PV-Echtblau B2G01 | flakes, e.g. SS fine steel |
| | PV-Echtgrün GG01, | flakes, by Novamet |
| | by Hoechst | |
| Acryl-based water | Paliogen Schwarz | Angle-oriented SS fine |
| lacquer | L0086 | steel flakes, by Novamet |
| | Hostatint Blau B2G | |
| Polyurethane-based | Hostatint Blau B2G | Paliochrom Orange |
| water lacquer | Hostatint Rot FGR | L2800, |
| | Ropaque OP62LEO | Paliochrom Gold L2020 |

A combination of an aqueous lacquer or an aqueous dispersion (especially a dispersion containing Mowilith® and, optionally, the usual defoaming agents and pigment dispersers) with a red, a blue and, optionally, a green organic pigment as the first pigments (especially Pigments from the Hostatint® programme of Hoechst and colour pigments from the D&C programme of Simple Pleasures, Old Saybrook, Conn. 06475, U.S.A) and with metal flakes which may optionally be aligned (especially aligned steel flakes) is especially preferred as the second pigments.

The following examples will illustrate the subject matter of the invention in greater detail.

### EXAMPLE 1

| | |
|---|---|
| 100.0 g | of binder consisting of |
| | 37 g of Alpex CK 450, by Hoechst |
| | 23 g of Novares LA 300, by Rütgers VfT |
| | 40 of white spirit 180/210 |
| 15.0 g | of zinc flakes, by Novamet |
| 5.0 g | of Hostatint Blau B2G, by Hoechst |
| 1.0 g | of Hostatint Rot FGR, by Hoechst |
| 3.0 g | of Sachtolith L, by Sachtleben |

After dispersing in a mixer, the mixture was applied to a commercial staining test card, dried in an oven and then measured spectrally. The results were as follows:

| Example No. | Solar absorption | Thermal emission |
|---|---|---|
| 1 | 58% | 46% |

### EXAMPLE 2

| | |
|---|---|
| 102.0 g | of water with 2% of Tylose MH 2000, by BASF |
| 45.0 g | of Mowilith DM 611, by Hoechst |
| 10.0 g | of Hydrolux PM Reflexal 100, by Eckhart |
| 1.0 g | of Byk 023 defoaming agent, by Byk |
| 1.0 g | of pigment disperser N, by BASF |
| 1.5 g | of Hostatint Blau B2G, by Hoechst |
| 0.5 g | of FD&C Red # 333, by Simple Pleasures, U.S.A. |
| 2.0 g | of Sachtolith L, by Sachtleben |

After dispersing in a mixer, the mixture was applied to a commercial staining test card, dried in an oven and then measured spectrally. The results were as follows:

| Example No. | Solar absorption | Thermal emission |
|---|---|---|
| 2 | 61% | 56% |

### EXAMPLE 3

| | |
|---|---|
| 500.0 g | of water with 2% of Tylose MH 2000, by BASF |
| 60.0 g | of Mowilith DM 611, by Hoechst |
| 60.0 g | of Poligen PE, by BASF |
| 3.0 g | of Byk 23 defoaming agent, by Byk |
| 3.0 g | of pigment disperser N, by BASF |
| 500.0 g | of zinc sulfide E8Z, 8.5 μm, by Sachtleben |
| 200.0 g | of water |
| 30.0 g | of Expancel 551 DE 20, by Akzo Nobel |
| 20.0 g | of Bayferrox 130 B, impasted in water, by Bayer |
| 10.0 g | of Hostatint Blau B2G, by Hoechst |

After dispersing in a mixer, the mixture was applied to a commercial staining test card, dried in an oven and then measured spectrally. The results were as follows:

| Example No. | Solar absorption | Thermal emission |
|---|---|---|
| 3 | 53% | 68% |

### Comparative Example

For comparison, spectral measurements were taken of a commercial, dark coating of an instrument panel for passenger vehicles on acrylate vinyl acetate basis which was dyed a dark colour mainly with colour black. The results were as follows:

| Example | Solar absorption | Thermal emission |
|---|---|---|
| Comparative example | 85% | 88% |

### Summary of the Results

| Example | Solar absorption | Thermal emission |
|---|---|---|
| 1 | 58% | 46% |
| 2 | 61% | 56% |
| 3 | 53% | 68% |
| Comparative example | 85% | 88% |

The comparison of the measured data shows that a conventional dark coating absorbs far more solar energy than the coating with spectral selectivity of the invention.

Owing to its higher degree of emission, the conventional coating also emits markedly more heat than the dark coatings of the invention.

### Example for Surface-treated Metal Pigments

A basic lacquer with the following components was mixed:

| | |
|---|---|
| 100.0 g | of binder, consisting of |
| | 37 g of Alpex CK 450, by Hoechst |
| | 23 g of Novares LA 300, by Rütgers VfT |
| | 40 g of white spirit 180/210 |

20 g of aluminium platelet oxidised in a thermal process were added to this basic lacquer and stirred. The aluminium platelets had a dark-red thermo-recording paint. In the dried state, this resulted in a dark-red lacquer layer with a metallic effect.

In another experiment, Paliochrom Gold L 2000 metal pigments by BASF were added to the basic lacquer. In the dried state, this resulted in a lacquer layer with a deep golden sheen.

The colouring effect of the surface-treated metal pigments results from metal oxides of nm fineness which protect the surface in addition to giving colour. The red aluminium platelet is a thermo-recording paint which evolves by heating whereas the surface is coated with an Fe₂O₃ iron oxide in Paliochrom Gold.

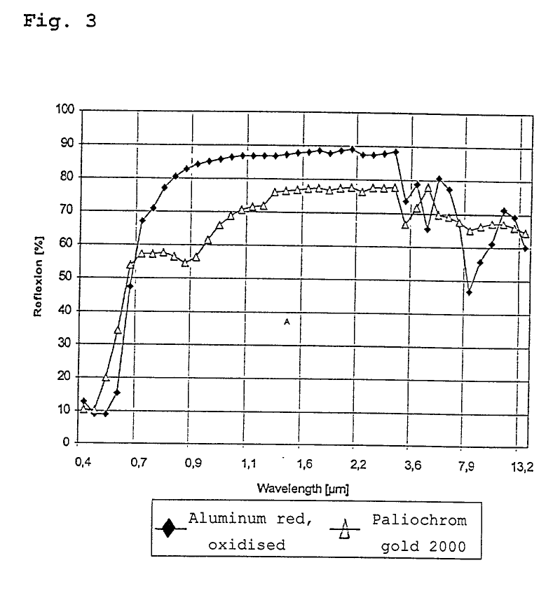

Both lacquer samples were then subjected to spectral measurement. FIG. 3 shows the measured results in the form of a diagram. Both lacquer layers show a pronounced absorption behaviour in the visible range of the electromagnetic spectrum. In the near-infrared range of the spectrum of 0.7 to 2.5 μm, on the other hand, they have the desired high degree of reflection. In the range of thermal infrared the resulting reflection of the lacquer layer was largely above 50%.

In an additional experiment, the lacquer mixtures were stained with Hostatint Blau B2G by Hoechst, resulting in deep blue, dark hues with similar spectral curves as in FIG. 3, but with a more pronounced absorption in the visible range of the spectrum.

The following is a particularly preferred example for surface-treated metal pigments in an aqueous binder:

20.0 g of water with 2% of Tylose MH 2000, by BASF

10.0 g of Mowilith DMM 771, by Hoechst

0.2 g of Byk 023 defoaming agent, by Byk

0.2 g of pigment disperser N, by BASF

30.0 g of black tinting paste, consisting of

80.0 g of water

40.0 g of Mowilith DN 771

0.3 g of pigment disperser N

12.0 g of Paliogen Schwarz L0086, by BASF

The tinting paste was mixed with the aid of 1.5 milling balls for 45 min.

10.0 g of Paliochrom Orange slurry, consisting of

49.2 g of butyl glycol

50.0 g of Paliochrom Orange L2800

0.8 g of Korantin SMK, by BASF

The mixture was stirred for 15 min.

0.1 g of Hostatint Rot FGR

After dispersing in a mixer, the mixture of the above components was applied to a commercial staining test card, dried in an oven and then subjected to spectral measurement. Solar absorption was only 58%, even though the optical impression of the colour was a dark anthracite. The degree of thermal emission of the colour was 62%.

### Example of a Coating With an Angle-dependent Degree of Emission

20.0 g of water with 2% of Tylose MH 2000, by BASF

10.0 g of Mowilith DMM 771, by Hoechst

0.2 g of Byk 023 defoaming agent, by Byk

0.2 g of pigment disperser N, by BASF

10.0 g of SS fine steel flakes, by Novamet

0.1 g of D&C Red # 33, by Simple Pleasures Old Saybrook

0.3 g of Hostatint Blau B2G, by Hoechst

After dispersing in a mixer, the mixture was applied to a commercial staining test card and exposed to a magnetic field while wet so that the steel flakes in the binder rose up to an angle of 45°. Then the sample was dried.

From one viewing angle, the coating had a metallic, blue to violet appearance, and the degree of thermal emission in this direction was 0.54. Viewed from the opposite angle, the coating was a very dark blue to almost black. Measured from this direction, the degree of thermal emission was 0.92.

In addition to the lower heat load for both the driver and the passenger due to the lower degree of emission of the coating, the optical appearance is of particular significance when using such coatings on the front deposit surface (ledge) of a passenger vehicle. Thus, the coating according to the invention may have a pleasant and bright colour on the side facing the driver and passenger, whereas it is dark in the direction of the windscreen and therefore is not reflected by said screen.

### Commercial Applicability

In particular, the coatings with spectral selectivity according to the invention may be used as coatings for the front deposit surface (ledge) in motor vehicles. Deposit surfaces for motor vehicles provided with a coating according to the invention constitute another aspect of the present invention.

1. A coating with spectral selectivity comprising
a) a binder having a transmission of 60% or more in the near-infrared wavelength range of 0.7 to 2.5 ,m and a transmission of 40% or more in the thermal infrared wavelength range;
b) first pigments which absorb 40% or more of the visible light in the wavelength range of 0.35 to 0.7 μm, have a backscatter of 40% or more in the near-infrared range of 0.7 to 2.5 μm and have an absorption of 60% or less in the thermal infrared wavelength range;
c) second pigments having a backscatter and/or reflection of 40% or more in the thermal infrared wavelength range.

2. A coating with spectral selectivity according to claim 1, characterised in that
a) the binder has a transmission of 75% or more in the near-infrared wavelength range of 0.7 to 2.5 μm and a transmission of 50% or more in the thermal infrared wavelength range;
b) the first pigments absorb 60% or more of the visible light in the wavelength range of 0.35 to 0.7, have a backscatter or 50% or more in the near-infrared range of 0.7 to 2.5 μm and have an absorption of 50% or less in the thermal infrared wavelength range; and
c) the second pigments have a backscatter and/or reflection of 50% or more in the thermal infrared wavelength.

3. A coating with spectral selectivity according to claim 1 or 2, characterised in that the binder is selected from at least one of the following groups:
a) aqueous dispersions and emulsions on the basis of acrylates, styrene acrylate, polyethylene, polyethylene oxidate, ethylene acrylic acid copolymer, methacrylate, vinyl pyrrolidone vinyl acetate copolymers, polyvinyl pyrrolidone, polyisopropyl acrylate, polyurethanes, terpene and rosin resins;
b) binders containing solvents, comprising acryl, cyclised and butyl rubber, hydrocarbon resins, terpene resins, nitro, acetyl and ethyl cellulose, α-methyl styrene acrylonitrile copolymers, polyester imide, acrylic acid butyl esters, poly(meth)acrylic acid esters, polyurethanes, aliphatic polyurethanes, chlorosulfonated polyethylene and
c) thermoplastic materials such as polyolefins and polyvinyl compounds, especially polyethylene, polypropylene, Teflon®, polyamide.

4. A coating with spectral selectivity according to at least one of the previous claims, characterised in that the first pigments are selected from at least one of the following groups:
a) inorganic pigments, selected from lead compounds, zinc, iron, chromium, cadmium, barium, titanium, cobalt, aluminium and silicon compounds, especially red iron oxides, chrome oxide green, chrome oxide hydrate, ultra marine blue and iron cyanide blue;
b) organic pigments, comprising natural dyes of animal and plant origin as well as synthetic organic dyes and pigments, especially monoazo pigments, diazo pigments, indigo pigments, perylenes, quinacridones, dioxazines, metal-free phthalocyanines, especially phthalocyanine pigment blue.

5. A coating having spectral selectivity according to at least one of the previous claims, characterised in that the first pigments are transparent or translucent pigments, especially transparent iron oxides and transparent organic pigments.

6. A coating having spectral selectivity according to at least one of the previous claims, characterised in that the second pigments are platelet-shaped and are selected from at least one of the following groups:
a) metal and/or metal alloys, selected from aluminium, aluminium bronze, antimony, chromium, iron, gold, iridium, copper, magnesium, molybdenum, nickel, palladium, platinum, silver, tantalum, bismuth, tungsten, zinc, tin, bronze, brass, nickel silver, a nickel/chromium alloy, niccolite, constantan, manganin and steel;
b) electrically non-conducting materials coated and/or covered with metal or metal alloys, said metals being selected from aluminium, aluminium bronze, antimony, chromium, iron, gold, iridium, copper, magnesium, molybdenum, nickel, palladium, platinum, silver, tantalum, bismuth, tungsten, zinc, tin, bronze, brass, nickel silver, a nickel/chromium alloy, niccolite, constantan, manganin, steel or electrically conducting stannous oxide;
c) laminated pigments composed of at least three layers, the middle layer having a smaller refractive index than the outer layers and the materials thereof being selected from the group of materials having a transmission of ≧20%, preferably ≧40% in the wavelength range of 5 to 25 μm.

7. A coating with spectral selectivity according to at least one of the claims 1, 2 and 6, characterised in that the second pigments are surface-treated, platelet-shaped metal pigments, the surfaces of which have been treated in such a manner that they absorb more than 40%, preferably more than 60% of the visible light in the wavelength range of 0.35 to 0.7, have a reflection of more than 50%, preferably more than 60% in the near-infrared range of 0.7 to 2.5 μm and have a reflection of more than 40%, preferably more than 50% in the thermal infrared wavelength range.

8. A coating having spectral selectivity according to at least one of the claims 1 to 5, characterised in that the second pigments are approximately spherical and are substantially single crystals, the mean diameter d of the single crystals being determined by the formula
d=14 μm/2.1·(n_{T 14}−n_{B 14}),
wherein n_{T 14} is the refractive index of the spherical particle at a wavelength of 14 μm and n_{B 14} is the refractive index of the binder at a wavelength of 14 μm.

9. A coating with spectral selectivity according to claim 1 or 2, characterised in that the second pigments are selected from the group consisting of metal sulfides, metal selenides, metal fluorides, metal carbonates, metal antimonites, metal oxides, barium titanate, barium ferrite, calcium sulfate, barium sulfate and of mixed crystals of said substances, especially mixed crystals of barium sulfate with zinc sulfide.

10. A coating with spectral selectivity according to claim 1 or 2, characterised in that the second pigments are hollow spheres having a diameter of 10 to 100 μm, preferably 10 to 30 μm, the wall of which consists of at least one material selected from acrylate, styrene acrylate, acrylonitril copolymer, polyethylene, polyethylene oxidate, chlorosulfonated polyethylene, ethylene acrylic acid copolymer, methacrylate, vinyl pyrrolidone vinyl acetate copolymer, vinylidene chloride copolymer, polyvinyl pyrrolidone, polyisopropyl acrylate, polyurethane, from cyclised rubber, butyl rubber, hydrocarbon resin, α-methyl styrene acrylonitrile copolymer, polyester imide, acrylic acid butyl ester, polyacrylic acid ester.

11. A coating with spectral selectivity according to at least one of the claims 1, 2, 8, 9 and 10, characterised in that the second pigments are a mixture of single crystals and hollow spheres.

12. A coating with spectral selectivity according to at least one of the claims 1, 2, 6 and 7, characterised in that the second platelet-shaped pigments in the binder are aligned in such a manner that they form an angle of 30° to 60° to the normal line of the surface.

13. A coating with spectral selectivity according to claim 1 or 2, characterised in that additional pigments are used to achieve a matting effect, said additional pigments having a transmission of 40% or more, preferably 50% or more in the thermal infrared wavelength range and being approximately spherical and substantially being single crystals, the mean diameter d of the single crystal being determined by the formula
d=λ/2.1·(n_{T}−n_{B}),
wherein n_{T} is the refractive index of the spherical particle at the wavelength λ, n_{B} is the refractive index of the binder at a wavelength of λ and λ is a wavelength in the range of visible light.

14. A coating with spectral selectivity according to at least one of the claims 1, 2 and 13, characterised in that the additional pigments are selected from the group of metal sulfides, metal selenides, fluorides, carbonates, antimonides, metal oxides, barium titanate, barium ferrite, calcium sulfate, barium sulfate and from mixed crystals of representatives of the groups enumerated, especially mixed crystals of barium sulfate with zinc sulfide.

15. A coating with spectral selectivity according to claim 1 or 2, characterised in that opaque polymer pigments and/or organic pigments are used as additional pigments for matting purposes, said pigments having a transmission of 30% or more, preferably 40% or more in the thermal infrared wavelength range, having and/or forming a cavity in the dry state and the size of the polymeric or organic pigments being selected in such a manner that their mean diameter is 0.2 to 2.0 μm, preferably 0.4 to 0.8 μm.

16. A coating with spectral selectivity according to claim 1 or 2, characterised in that transparent red, green and blue pigments are used in addition to the first pigments.

17. The use of a coating with spectral selectivity according to at least one of the previous claims as a coating for deposit surfaces (ledge) in motor vehicles.
